(19) United States
(12) Patent Application Publication
(10) Pub. No.: US 2010/0283432 A1
(43) Pub. Date: Nov. 11, 2010

(54) Vehicle Timing Apparatus

(76) Inventors: Simon Ellwanger, Palo Alto, CA (US); Gary Fitzergerald, Newbury Park, CA (US); Jeff Zabel, Palo Alto, CA (US)

Correspondence Address: BARLEY SNYDER, LLC, 1000 WESTLAKES DRIVE, SUITE 275, BERWYN, PA, 19312, US

(21) Appl. No.: 12/463,782

(22) Filed: May 11, 2009

(51) Int. Cl. H02J 7/04; G04B 47/00; G06Q 10/00; G06Q 50/00

(52) U.S. Cl. 320/155; 368/10; 705/7

(57) ABSTRACT

The present invention relates to a timing apparatus and methods of its use in quantifying the time parameter of being away from a vehicle. The timing apparatus having a menu included with a set of numbers corresponding to user selectable time parameters, a control knob adjustable to designate a selected time parameter from the set of numbers, the selected time parameter representing the time until the vehicle will be turned back on, and a sensor connected to the control knob and a microprocessor, the sensor providing a proximate selected position of the control knob in reference to the set of numbers, the selected position representing the selected time parameter.

### FIELD OF THE INVENTION

The invention relates to a timing apparatus and methods of its use in quantifying a time parameter denoting expected time away from a vehicle.

### BACKGROUND

The automotive industry continually invests money and time in making cars more energy efficient.

Electrical vehicles (EV) and Plug-In Electrical Vehicles (PHEV), unlike vehicles with an internal combustion engine (ICE), have become ever increasingly popular, in that these vehicles provide lower emitted pollutants and greenhouse gases, as well as lower energy costs in the midst of higher gas prices.

Indirectly, gasoline is either substituted or completely replaced by whatever is being used to generate domestic electricity. In fact, renewable, nuclear, natural gas, coal and domestic petroleum can be used to generate the electricity needed to power these vehicles. Additionally, carbon based energy may also be avoided.

However, these electrical vehicles are considered energy inefficient unless the batteries that they use are charged efficiently and the charge is well maintained. Optimizing the charging process and charging rate of these batteries is much needed.

Algorithms used to charge vehicles are well known. For instance, the Society of Automotive Engineers International (SAE) has encouraged the utilization of a proposed algorithm for communication between plug-in electric vehicles and the electric vehicle supply equipment (EVSE), for energy transfer and other applications (see FIG. 1). In order to charge an electric vehicle (EV) or Plug-In Electric Vehicle (PHEV) in an optimal way, the SAE algorithm includes following parameters (a) energy that the battery need to be charged [in KW/hr], (b) maximal electric line power of the connection to the car [in KW], (c) electric price at any point in time [in $ per KW/hr], and (d) an estimate of how long the car will be parked and plugged in [in Hr]. While the parameters (a) to (c) are known and can be transmitted to the car through a electronic vehicle supply equipment (EVSE), the parameter (d) is proposed to be estimated. Providing the actual time parameter would be provide a robust algorithm to optimize charging.

U.S. Pat. No. 7,358,701 discloses a system and method for calculating an energy transfer profile based upon a particular application environment and a particular charging model. The disclosed method requires a first step 102 of setting a threshold current level required to trigger the beginning of a data acquisition cycle. Then, in step 104, the duration of the time interval is established (see FIG. 2). These steps 102 and 104 may include communicating “these parameters” to the microcomputer 30 from an external device by way of the communication port 34. The microcomputer 30 uses the parameters in the execution of computer code or a computer software program for implementing a data acquisition algorithm.

However, the required step for a time interval disclosed in '701 is only to reduce the amount of measuring time for data acquisition. The reference teaches, in 104 FIG. 3, a “set time interval” and then it takes measurements until the end of that time interval. The time interval is not estimated by a user nor even changed during the process. Furthermore, the time interval does not change, influence, or optimize a charging algorithm or method.

Preparing an expected time parameter, that references how long a vehicle is idle/parked at a specific moment in time, would better optimize many algorithms employed in the vehicle, including the charging of a vehicle battery. More specifically, a time parameter that is determined by a user in real-time rather than a time parameter prepared using past data history would be beneficial.

U.S. Patent Publication 2008/0007202 discloses a vehicular charging system, configured to be charged from an external power source, comprising a battery assembly and a timer coupled to the battery assembly. The timer is configured to electrically couple the external power source to the battery assembly to commence charging the battery assembly at a predetermined charge initialization time. Although the disclosed timer is used to optimize charge capabilities, the timer is used to determine a preferred charge termination time. Fundamentally, the user specifies a “charge start time” and “preferred charge termination time”. The charging is delayed until the preferred “charge start time”. It would be desirable to provide an expected time parameter, for how long a vehicle is idle/parked at that specific moment, which would better optimize the charging of a vehicle battery.

In addition to the aforementioned progression, car manufacturers have been making efforts to create more efficient climate control systems. As is well known, a vehicle climate control system will include a compressor, a condenser and an evaporator (see FIG. 3). Commonly referred to as the heart of the system, the compressor is a belt driven pump that is fastened to the engine. It is responsible for compressing and transferring refrigerant gas. The more the condenser works, the less the climate control system efficiently operates, as fuel consumption is directly related to climate control. Currently, there is no way of providing the vehicle climate control system a reference, or time parameter, when the operator will return to the vehicle. If there was such a reference, the vehicle could advance the climate control system before the operator returned to the vehicle, therefore limiting the amount that the condenser has to work to cool the vehicle during operation.

### SUMMARY

Accordingly, the present invention was devised in light of the problems described above, the invention relates to a timing apparatus and methods of its use in quantifying the time parameter in which an operator will be away from a vehicle.

The timing apparatus for a vehicle has a menu, control knob, sensor and a microprocessor. The menu includes a set of numbers corresponding to user selectable time parameters. The control knob is adjustable to designate a selected time parameter from the set of numbers, wherein the selected time parameter represents the time until the vehicle will be turned back on. The sensor is connected to the control knob and the microprocessor, such that the sensor provides a proximate selected position of the control knob in reference to the set of numbers, the selected position representing the selected time parameter.

The invention further relates to a method to optimize an electrical charging procedure of a vehicle, comprising the steps of: (a) determining an amount of time until the vehicle will be turned on, (b) selecting the amount of time from a menu having a set of numbers corresponding to user selectable time parameters, (c) positioning a control knob having a marker to a selected time parameter representing the amount of time until the vehicle, and (d) inputting the selected time parameter into a charging algorithm.

Additionally, the invention relates to a method of optimizing use of a climate control system in a vehicle; comprising the steps of: (a) determining an amount of time until the vehicle will be turned on, (b) selecting the amount of time from a menu having a set of numbers corresponding to user selectable time parameters, (c) positioning a control knob to a selected time parameter representing the amount of time until the vehicle, and (d) inputting the selected time parameter into a climate control module, the climate control module activated before the vehicle is turned on.

### BRIEF DESCRIPTION OF THE DRAWINGS

The invention will be explained in greater detail with reference to embodiments, referring to the appended drawings, in which:

FIG. 1 is a flow diagram detailing parameters implemented into a known charging algorithm;

FIG. 2 is a flow diagram detailing a method of recording or collecting data according to a known charging algorithm;

FIG. 3 is an illustrative representation of a known vehicle climate control system;

FIG. 4 is a flow diagram of a timing apparatus and user modules according to the invention;

FIG. 5 is a flow diagram illustrating a battery charging system according to the invention;

FIG. 6 is one embodiment of the timing apparatus according to the invention;

FIG. 7 is a second embodiment of the timing apparatus according to the invention;

FIG. 8 is a third embodiment of the timing apparatus according to the invention;

FIG. 9 is a fourth embodiment of the timing apparatus according to the invention;

FIG. 10 is a fifth embodiment of the timing apparatus according to the invention;

FIG. 11 is a sixth embodiment of the timing apparatus according to the invention;

FIG. 12 is a seventh embodiment of the timing apparatus according to the invention;

FIG. 13 is a flow diagram illustrating a climate control system according to the system.

### DETAILED DESCRIPTION OF THE EMBODIMENT(S)

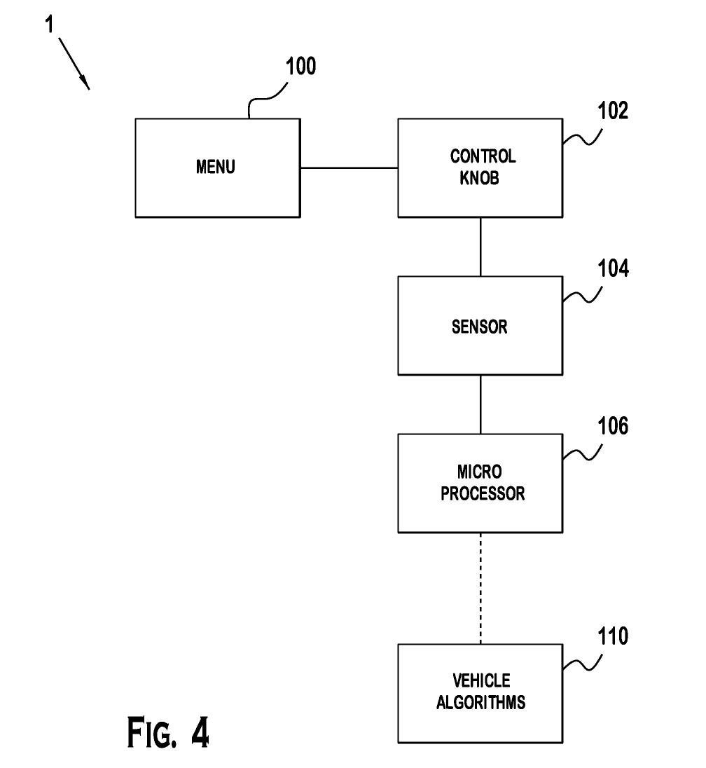

The invention will now be described in greater detail first with reference to FIGS. 4-13.

The present invention relates to a timing apparatus 1, as shown in FIG. 4, having several modules including a menu 100, a control knob 102, a sensor 104 and a microprocessor 106. The timing apparatus 1 is used to prepare a time parameter that will then be utilized by any number of vehicle module algorithms 110, including a battery-charging algorithm 122 (see FIG. 5).

The menu 100, in FIG. 4, is an interface displaying user selectable time parameters. Each of the selectable time parameters capable of being a single selected time parameter that represents an expected time a vehicle is turned-off, idle, or that the user is away from the vehicle.

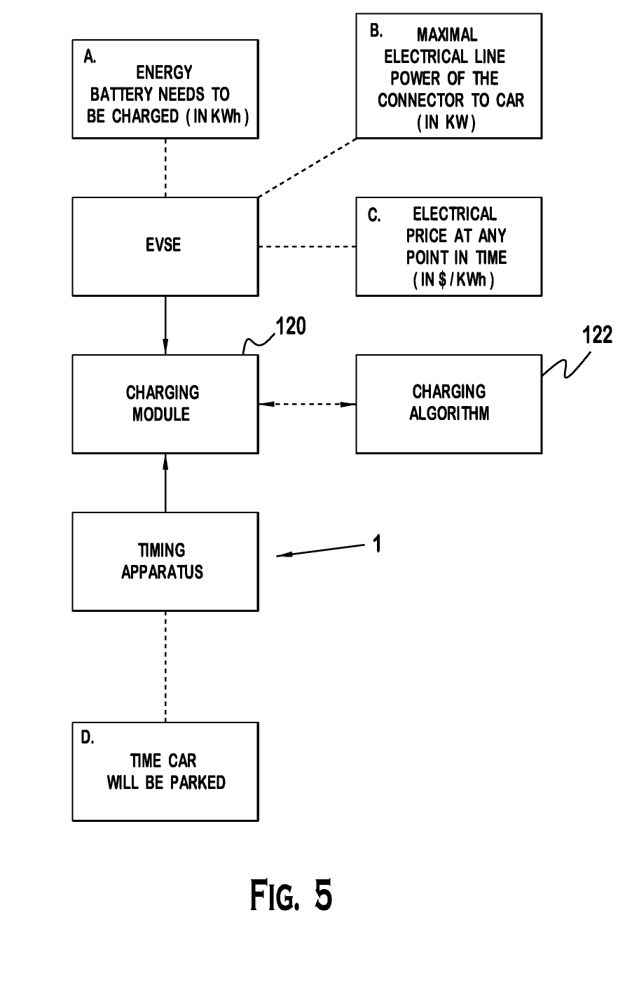

In one embodiment, the menu 100 is a physical housing having a circular shape, wherein the user selectable time parameters are displayed around the housing (see FIG. 6). However, various embodiments, including several forms of the menu 100, will be discussed further below.

The control knob 102, defined as a module in FIG. 4, is generally positioned within reach of the user, and is adjustable. The knob 102 allows the user to select one of a plurality of selectable time parameters, each knob position representing a potential selected time parameters. Coupled to the control knob 102 is a knob position sensor 104. The sensor 104, like other known sensors, is a device that measures a physical quantitative movement and placement of the control knob 102 with respect to positions along the menu 100. That measurement is converted by the sensor 104 into a signal that is sent and stored by the microprocessor 106. The microprocessor 106 connects to separate vehicle modules, where specific modules utilize the inputted time parameter for running vehicle algorithms 110. For instance, the selected time parameter optimizes vehicle performance, such as battery charging of a electrical vehicle or efficient climate control.

As discussed above, FIG. 6 displays one embodiment of the invention, where the menu 100 is a physical housing having a circular shape and user selectable time parameters are displayed around the housing. The timing apparatus 1, as shown, includes a menu 100 having user selectable time parameters within a subset of numbers menus 200, 204, and 206. Each subset of numbers menu 200, 204, and 206 represent user selectable time parameters, including a minutes menu 200, hours menu 204 and days menu 206. Additionally, the timing apparatus 1 is further provided with a “greater than” selection 208. As an additional user selectable time parameter in the embodiment shown, the “greater than” selection 208 would be a time parameter representing the user selected time parameter that is larger than the largest selectable time parameter value displayed and selectable by the user. For instance, in the embodiment shown, the largest select user selectable time parameter available is 4 days. However, the user can select the “greater than” selection 208, which would provide a selected time parameter representing an indefinite time away from the vehicle. Although the selected “greater than” selection 208 does not provide a definite time parameter, the “greater than” selection 208 does provide a specified point of time reference, that provides a quantitative time above the greatest available time parameter. Therefore, if the “greater than” selection 208 is identified by the user as the expected time away from the vehicle, the microprocessor 106 will prepare a designated default time parameter to be used with any of the vehicle's algorithms 110, that time being quantatively larger than the largest selectable time parameter.

Each of the subset of numbers 200, 204, and 206, displayed in FIG. 6, represent user selectable time parameters that increase in a uniform manner. For instance, the user selectable time parameters in the hours menu 204 increase by twofold. However, it is possible to have the time parameters increase non-uniformly, including but not limited to exponentially or cubically.

Furthermore, the timing apparatus 1 in the embodiment shown, includes a control knob 102 that is rotatable about an axis extending through the control knob 102. The control knob 102, having an indicator 102a (i.e. an arrow), which turns about the subset of numbers menus 200, 204, and 208, as well as the “greater than” selection 208 with the arrow reflecting the user selected time parameter of choice. The sensor 104, used with the timing apparatus 1 shown, is a rotational sensor that detects a rotary position of the control knob as it is positioned to the user selected time parameter.

FIG. 7 shows another embodiment of the timing apparatus 1. Like the embodiment shown in FIG. 6, the embodiment shown in FIG. 7 includes the menu 100 as a physical housing having a circular shape, wherein the user selectable time parameters are displayed around the housing. However, the timing apparatus 1, as shown, includes a menu 100 having a single set of user selectable time parameters, wherein one subset of numbers 210 is displayed. This subset of numbers 210 represents a variety of user selectable time parameters. Again, the timing apparatus 1 is further provided with a “greater than” selection 208, representing the user selected time parameter that is larger than the largest selectable time parameter value displayed and selectable by the user.

The single subset of numbers 210, as displayed in FIG. 7, represent user selectable time parameters that increase in a uniform manner. For instance, in the embodiment shown, the user selectable time parameters are in hours, increasing hourly with each viewable time parameter. However, it is possible to have the time parameters increase non-uniformly, including but not limited to exponentially or cubically. Therefore, the user could select from a variety of time parameters, that otherwise would not be displayable on a linear progression.

Additionally, the selectable time parameter is not held to only by the time periods being displayed, but rather the timing apparatus 1 realizes time parameters selectable between the viewable numbers. For instance, if the user has selected a time parameter between 1 and 2 hours, in the embodiment shown, then the timing apparatus 1 would prepare a time parameter corresponding to a fractional time between the two viewable time parameters.

The timing apparatus 1, in the embodiment shown, again includes a control knob 102 that is rotatable about an axis extending through the control knob 102. The control knob 102, having an indicator 102a (i.e. an arrow), which turns about the single subset of numbers 210, as well as the “greater than” selection 208 with the arrow reflecting the user selected time parameter of choice. The sensor 104, used with the timing apparatus 1 shown, is a rotational sensor that detects a rotary position of the control knob as it is positioned to the user selected time parameter.

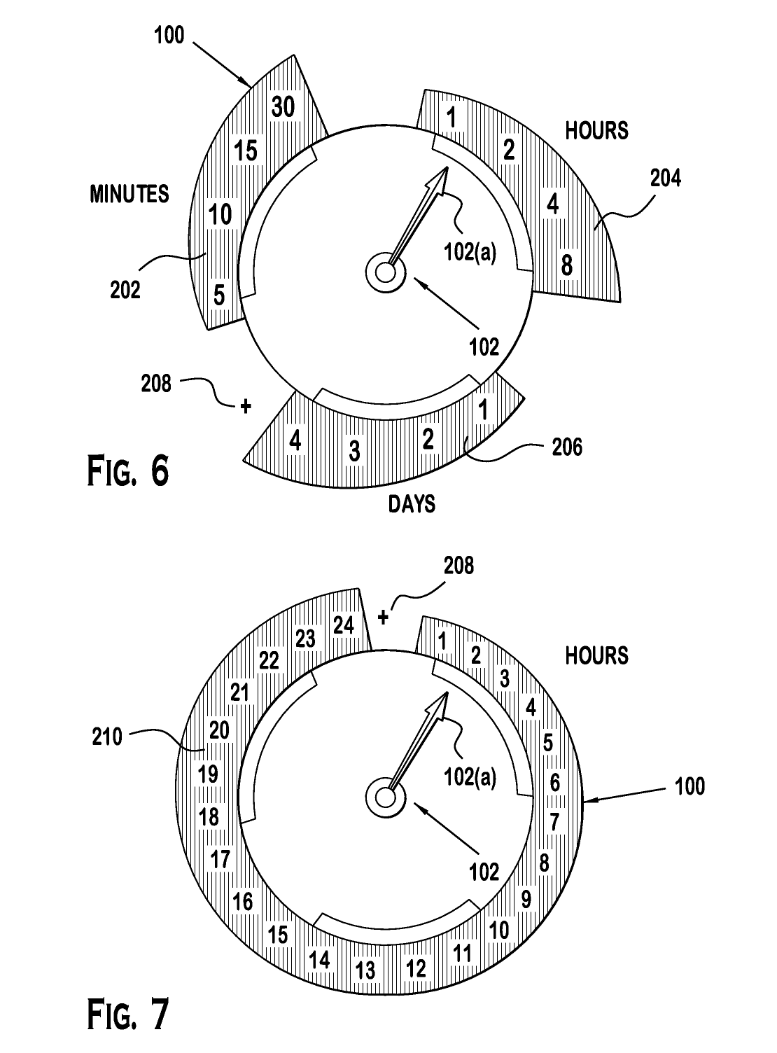

FIG. 8 shows another embodiment of the timing apparatus 1, wherein a single set of numbers 212 represents user selectable time parameters, viewed in days. As stated above, the selectable time parameter is not held only to the quantified time periods being displayed, but rather the timing apparatus realizes time parameters between the viewable numbers. Therefore, the timing apparatus is capable of providing the user a variety of selected time parameters to a vehicle algorithm, than what is actually displayed within the menu 100.

Another embodiment of the invention is shown in FIG. 9, where the menu 100 is a physical housing having a linear shape, wherein the user selectable time parameters are displayed at the top of the housing. The menu 100 includes user selectable time parameters within a subset of numbers menus 300, 302, and 304. Each subset of numbers menu 300, 302, and 304 represent user selectable time parameters, including a minutes menu 300, hours menu 302 and days menu 304. Again, the timing apparatus 1 is further provided with a “greater than” selection 308, representing the user selected time parameter that is larger than the largest selectable time parameter value displayed and selectable by the user. Each of the subset of numbers menus 300, 302, and 304, as displayed in FIG. 9, represent user selectable time parameters that increase in a uniform manner. However, as described in the other embodiments, it is possible to have the time parameters increase non-uniformly, such as exponentially or cubically.

Since the timing apparatus 1 includes a menu 100 that is linearly shaped, a control knob 102 is provided that is moveable in a linear degree of freedom approximately parallel to an axis extending through the control knob. The control knob 102 includes an indicator 102a (i.e. an arrow) that reflects the user selected time parameter of choice. The sensor 104, used with the timing apparatus 1 shown, is a linear sensor operative to detect a position of the control knob in regard to the set of numbers.

FIG. 10 shows another embodiment of the timing apparatus 1. Like the embodiment shown in FIG. 9, the embodiment shown in FIG. 10 includes the menu 100 as a physical housing having a linear shape, wherein the user selectable time parameters are displayed above the housing. However, the timing apparatus 1, as shown, includes a menu 100 having a single user selectable time parameters 308, wherein one subset of numbers 308 is displayed. This subset of numbers 308 represents a variety of user selectable time parameters.

As with all of the aforementioned embodiments, the timing apparatus 1 is further provided with a “greater than” selection 306, representing the user selected time parameter that is larger than the largest selectable time parameter value displayed and selectable by the user. However, it is also possible to exclude such a feature.

The single subset of numbers 308, as displayed in FIG. 10, represent user selectable time parameters that increase in a uniform manner. For instance, in the embodiment shown, the user selectable time parameters are in hours, increasing hourly with each viewable time parameter. However, it is possible to have the time parameters increase non-uniformly, including but not limited to exponentially or cubically. Therefore, the user could select from a variety of time parameters, that otherwise would not be displayable with a linear progression of time parameter increments.

Additionally, as discussed above, the selectable time parameter 1 is not held only to the time periods being displayed. Rather the timing apparatus 1 is capable of determining a time parameter selected between the viewable numbers.

The timing apparatus 1, in the embodiment shown, includes a control knob 102 that moves about an axis extending through the lengthwise direction L of the timing apparatus 1. The control knob 102, having an indicator 102a (i.e. an arrow), moves along this axis allowing the user to designate an expected time away from the vehicle using the single subset of numbers 308, as wells as a “greater than” selection 306. The sensor 104, used with the timing apparatus 1 shown, is a linear sensor that detects a linear position of the control knob as it is positioned to the user selected time parameter.

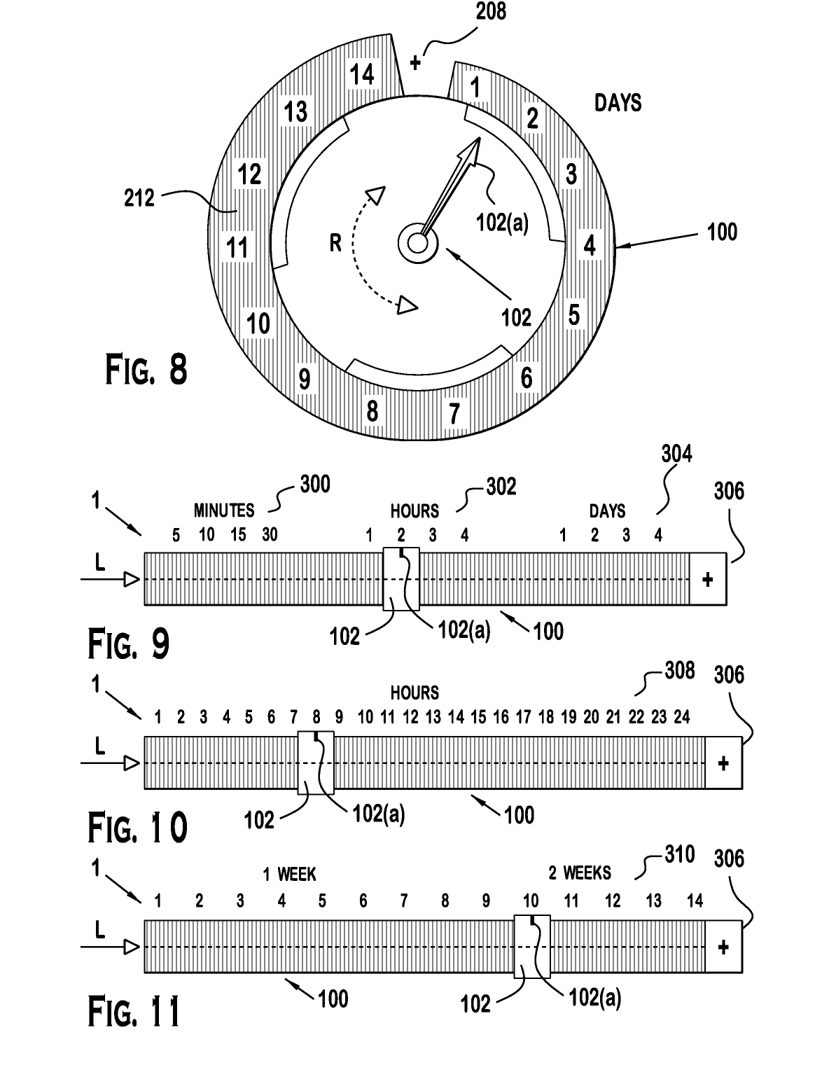

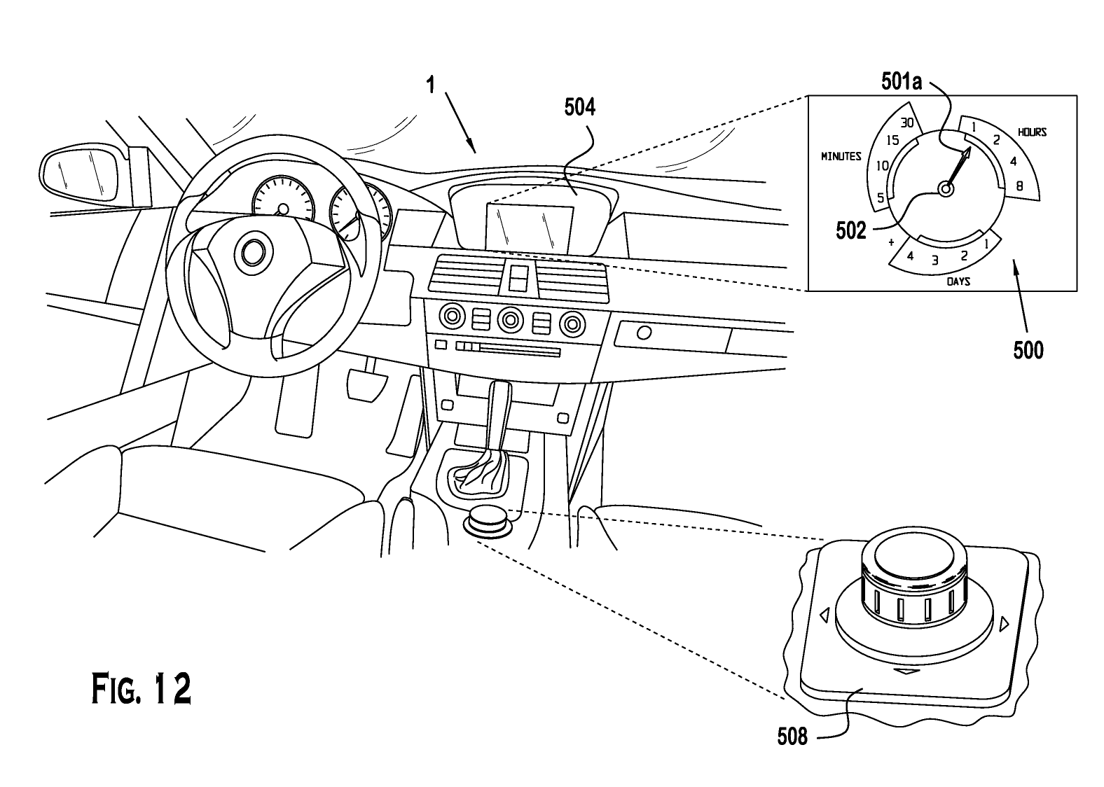

FIG. 11 shows another embodiment of the timing apparatus 1, wherein a single set of numbers 310 represents user selectable time parameters, viewed in days. As stated above, the selectable time parameter is not held only to the quantified time periods being displayed, but rather the timing apparatus 1 realizes time parameters between the viewable numbers.

FIG. 12 shows another embodiment of the invention, wherein the timing apparatus 1 for a vehicle includes a menu 500, illustrated as a graphical representation of the physical housing described above. The timing apparatus 1 includes a virtual menu 500 and virtual control knob 502, and is circular in shape. However, it is also possible to include a linear shaped virtual menu.

The menu 500 is displayable through an in-car display 504, which is an already existing in-car display or is added component to the vehicle. The virtual control knob 502 would be controlled by an already external control device 508 coupled to the in car display. It is possible that the external control device is an already existing control device or added as an aftermarket component. Either way, the external control device would be positioned near the user, and would control the virtual components of the menu 500 and the control knob 502.

When activated, the movement of the virtual control knob 502 matches movement of the existing control device 508. Therefore, the user may select a time parameter in the same way as described above, but through a virtual display. The timing apparatus would then be compatible with known vehicle display and select systems such as the BMW iDrive.

It is also possible to control the menu 500, using touch screen technology, whereby the external control device would not be required to control the virtual components.

The timing apparatus 1, described in any of the embodiments, would be include within reach of an operator, so that the user could conveniently adjust the expected time away from the vehicle. In addition, the timing apparatus 1, used with a plug-in electrical vehicle, would include a control knob that is positioned proximate to the electrical plug. The knob may be conveniently positioned next to the electrical plug in order to plug in the vehicle and set the selected time parameter for a charging algorithm.

It is also possible that the timing apparatus 1 is a mechanical timing apparatus Therefore, when the timing apparatus 1 is set by a user, then the timing apparatus 1 would clock down mechanically. Therefore, the timing apparatus would reset to zero automatically.

FIG. 5 illustrates a flowchart describing the use of various parameters for an electric vehicle charging algorithm. The timing apparatus 1, using any of the aforementioned embodiments, connects to a charging module 120. The charging module 120 controls the rate of charge and charge cycle, as well as other charging variables. Optimizing the charging process and charging rate of these batteries is desirable. In order to efficiently charge electric vehicle batteries, the charging module 120 will incorporate several charging parameters, which are then implemented into a charging algorithm 122 that determines the most efficient charging scheme. Therefore, the optimal charging scheme would be dependent on specific inputted parameters.

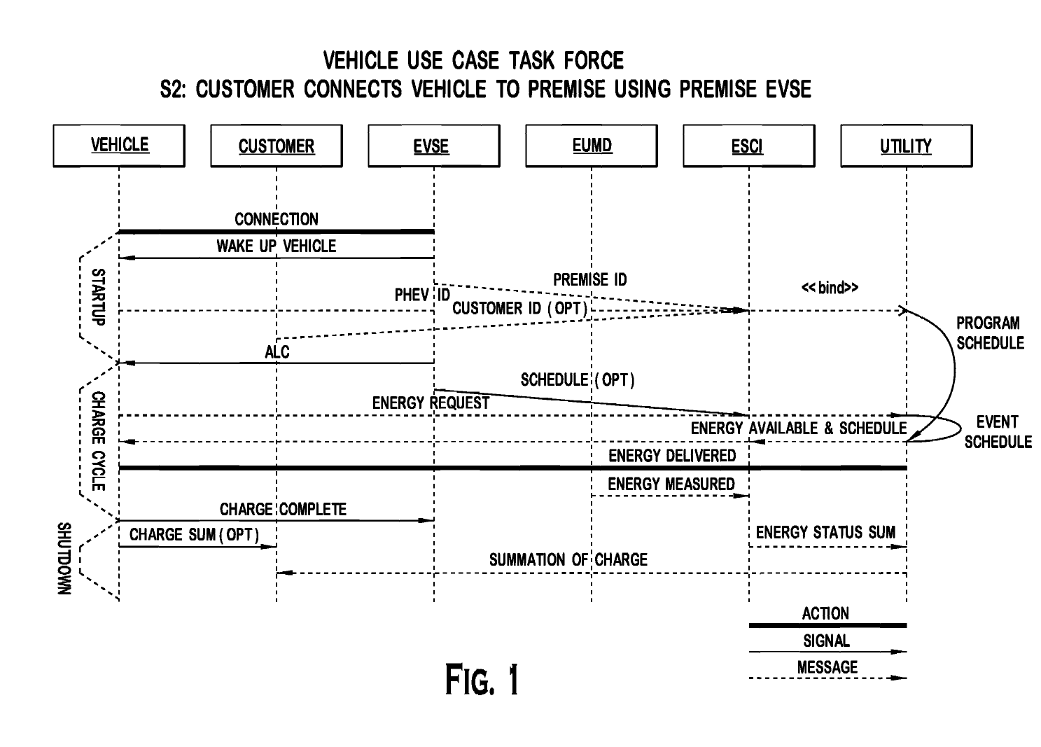

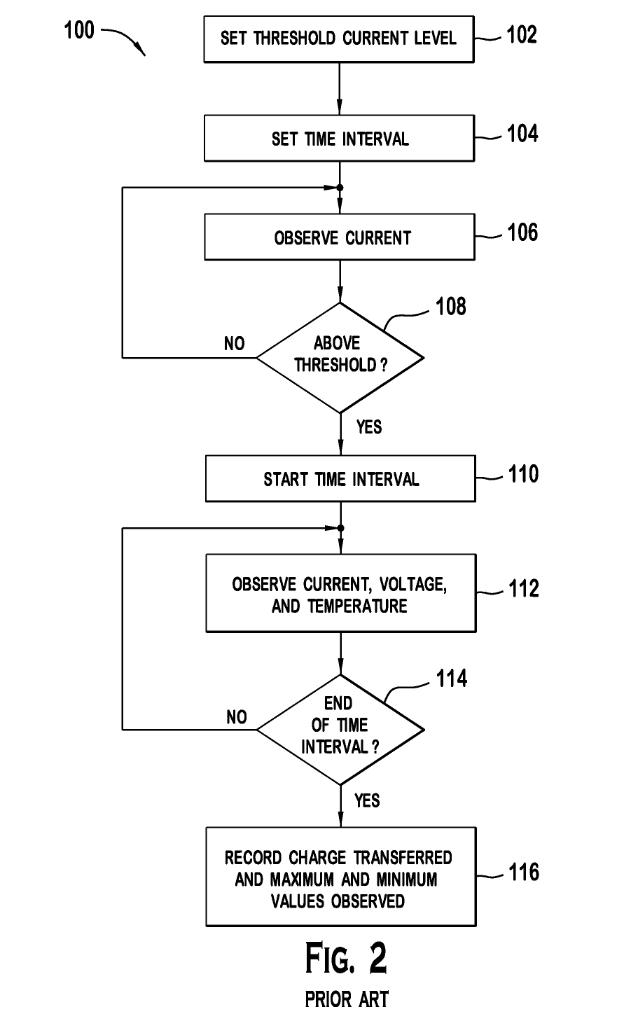

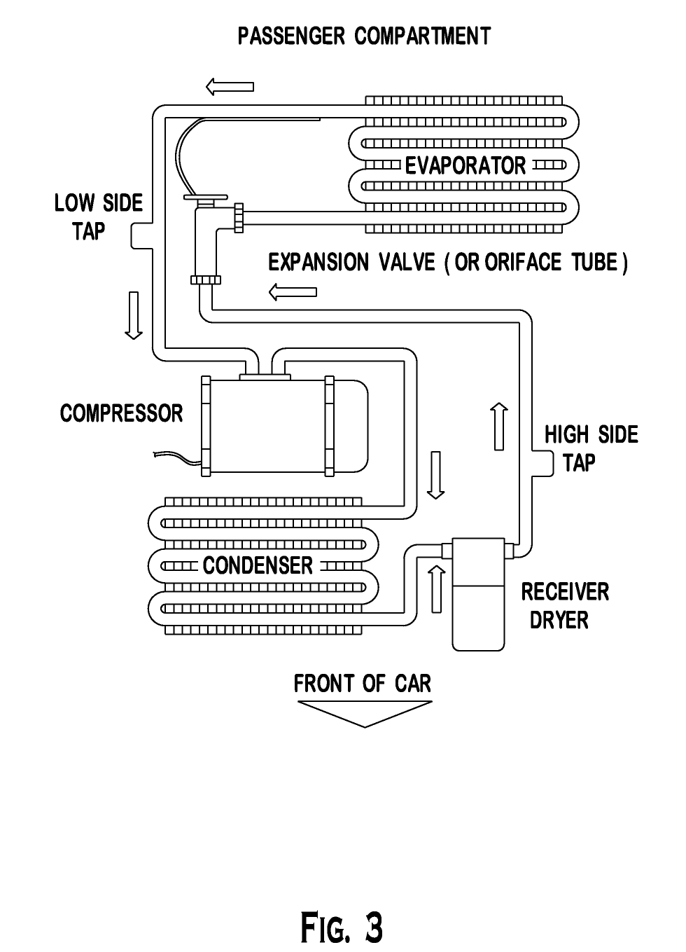

As discussed above, algorithms are commonly used to charge vehicles. For instance, the Society of Automotive Engineers International (SAE) has encouraged the utilization of a proposed algorithm for communication between plug-in electric vehicles and the electric vehicle supply equipment (EVSE), for energy transfer and other applications (see also FIG. 1). In order to charge an electric vehicle (EV) or Plug-In Electric Vehicle (PHEV) in an optimal way, the SAE algorithm includes following parameters (A) energy that the battery needs to be charged [in KW/hr], (B) maximal electric line power of the connection to the car [in KW], (C) electric price at any point in time [in $ per KW/hr], and an estimate of how long the car will be parked and plugged in [in Hr].

The parameters (A), (B) and (C) are readily known and can be transmitted to the car through a electronic vehicle supply equipment (EVSE). However, the time parameter is proposed to be an estimated period of time. That time parameter has no reference to start and stop times, but rather relies on an inexact estimated time parameter that is not provided by an individual user.

The timing apparatus 1 advantageously provides an actual time parameter (D) that would be included in a robust charging algorithm to optimize charging. The user selected time parameter (D) is implemented in to the charging algorithm 122 through the timing apparatus 1 and the charging module 120, in order to optimize charging of the vehicle batteries.

As a result, a more robust charging algorithm 122 is realized. More specifically, a method to optimize an electrical charging procedure of a vehicle is developed. Included in the optimal charging method, inter alia, are steps that provide the charging algorithm 122 with more information needed to optimize the charge. First, and foremost, a user would determine the amount of time, as a time parameter (D), that reflects the time a vehicle will be idle, the time a user is away from the vehicle, or when the vehicle will be turned back on. This time parameter (D) would be used to more closely estimate the real time the car is parked.

Therefore, an electrical charge algorithm may be optimized because the algorithm operates with a time parameter (D) provided to quantify the amount of energy needed over that time period in order to optimally charge the vehicle battery. Furthermore, since the maximal energy of a connection to the vehicle needed and energy price, during that time period, are known, vehicle batteries can be efficiently charged, environmentally and monetarily.

If the user does not select the time parameter (D), then a vehicle algorithm will be provided with the last positioned time parameter (D) if the timing apparatus does not mechanically count down, or would use a default. That default time parameter would substitute the expected time parameter (D) with a time parameter constant that is previously programmed into the vehicle algorithms, such as the “greater than” selections.

When charging an electric vehicle (EV) or Plug-In Electric Vehicle (PHEV), the time parameter (D) can be used to estimate a more reliable time of how long the car will be parked and plugged in [in hrs]. Even if the user does not come back at the exact time, the time parameter (D) could still be used to make a more educated guess about the parking time and therefore improve any kind of energy management algorithms (such as charging or climate control).

Without the user selected time parameter (D), the charging would rely only on a broad estimate of when the user would come back, that would be based either on past data or some predefined constant. It is much better to use the time parameter (D) to base the estimate on, than to perform decisions without a reference of time. The decision making process can be performed more efficiently, while the realized outcomes of those decisions are more effective.

Vehicle climate control systems have been further developed to provide more energy efficient and clean vehicles. In advance of those efforts, a vehicle climate control system utilizing a time reference, time parameter (D), of when the operator expects to return to the vehicle would be most beneficial. The timing apparatus 1 can be used to prepare a reference time parameter (D), which can also be utilized by the climate control system. The vehicle advancing with operation of the climate control system at some time before the operator returns to the vehicle. As such, the amount work required by the condenser can be limited and cooling the vehicle during operation can be produced more efficiently.

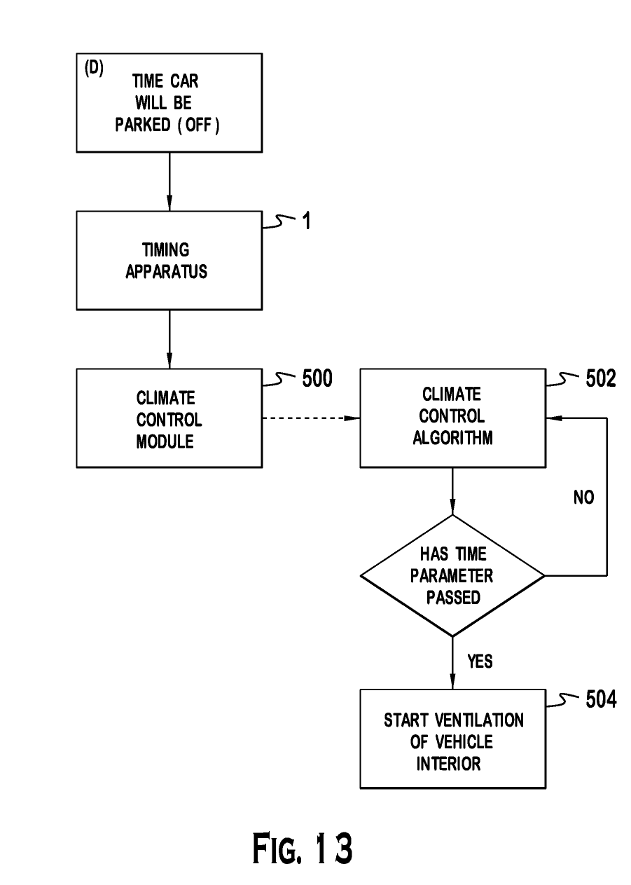

With reference to FIG. 13, the timing apparatus 1, as described above, connects to microprocessor 106 that further connects to a climate control module 500. The climate control module 500 controls and runs a climate control algorithm 502, with the selected time parameter (D) implemented into the climate control algorithm. As a result, the climate control algorithm 502 starts counting down from the selected time parameter (D). Once the time parameter (D) has passed, then the algorithm 502 would request that the climate control module 500 start ventilation 504.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A timing apparatus for a vehicle, comprising:
a menu displaying user selectable time parameters, a single selected time parameter being an expected time the vehicle is turned-off;
a control knob adjustable to select one of the time parameters from a plurality of knob positions, each knob position representing the plurality of selectable time parameters; and
a knob position sensor connected to the control knob and a microprocessor.

2. The timing apparatus for a vehicle of claim 1, wherein the menu is a physical housing having a circular shape, the user selectable time parameters surrounding the housing.

3. The timing apparatus for a vehicle of claim 1, wherein the menu is a graphical representation of a physical housing having a control knob and a circular shape, the menu displayable through an in-car display.

4. The timing apparatus for a vehicle of claim 1, wherein the user selectable time parameters are a subset of numbers.

5. The timing apparatus for a vehicle of claim 1, wherein the user selectable time parameters are a non-uniform increasing subset of numbers.

6. The timing apparatus for a vehicle of claim 1, wherein the control knob is rotatable about an axis extending through the control knob.

7. The timing apparatus for a vehicle of claim 6, wherein the sensor is a rotational sensor that detects a rotary position of the control knob,

8. The timing apparatus for a vehicle of claim 1, wherein the control knob is moveable in a linear degree of freedom approximately parallel to an axis extending through the control knob.

9. The timing apparatus for a vehicle of claim 8, wherein the sensor is a linear sensor operative to detect a position of the control knob in regard to the set of numbers.

10. The timing apparatus for a vehicle of claim 1, wherein the microprocessor is connected to a charging module controlling a charging algorithm, the selected time parameter implemented into the charging algorithm.

11. The timing apparatus for a vehicle of claim 1, wherein the microprocessor connected to a climate control module controlling a climate control algorithm, the selected time parameter implemented into the climate control algorithm.

12. The timing apparatus for a vehicle of claim 1, wherein the time parameter is a parameter estimate determinable by an operator.

13. The timing apparatus for a vehicle of claim 1, wherein the control knob is positioned within reach of an operator.

14. The timing apparatus for a vehicle of claim 1, wherein the control knob is positioned proximate to an electrical plug, the electrical plug connected to a charging module.

15. The timing apparatus for a vehicle of claim 1, wherein the control knob is an already existing control device coupled to the in car display, the control knob controlling a marker pointing to a selected time parameter from the set of numbers.

16. A method to optimize an electrical charging procedure of a vehicle, comprising the steps of:
determining an amount of vehicle idle time;
selecting the amount of time from a menu having a set of numbers corresponding to user selectable time parameters;
positioning a control knob having a marker to a selected time parameter representing the amount of time until the vehicle; and
inputting the selected time parameter into a battery charging algorithm.

17. The method to optimize an electrical charging procedure of a vehicle of claim 16, further comprising the step of detecting a position of the control knob in regard to the selected time parameter.

18. The method to optimize an electrical charging procedure of a vehicle of claim 16, wherein positioning of the control knob is performed by rotating the control knob about an axis extending through the control knob.

19. The method to optimize an electrical charging procedure of a vehicle of claim 16, wherein positioning of the control knob is performed by moving the control knob by a linear degree of freedom approximately parallel to an axis extending through the control knob.

20. The method to optimize an electrical charging procedure of a vehicle of claim 16, wherein positioning of the control knob is performed by controlling a graphical representation of the control knob through an already existing control device, the control knob being displayed through an on board display.

21. The method to optimize an electrical charging procedure of a vehicle of claim 16, wherein the set of numbers is a subset of numbers, further comprising the step of selecting the time parameter from the subset of numbers.

22. The method to optimize an electrical charging procedure of a vehicle of claim 16, wherein the set of numbers is a non-uniform but monotonically increasing subset of numbers, further comprising the step of selecting from the non-uniform but monotonically increasing subset of numbers.

23. A method of optimizing use of climate control system in a vehicle, comprising the steps of:
determining an amount of vehicle idle time;
selecting the amount of time from a menu having a set of numbers corresponding to user selectable time parameters;
positioning a control knob to a selected time parameter representing the amount of time until the vehicle; and
inputting the selected time parameter into a climate control module, the climate control module activation dependent upon selected time parameter.

24. The method of optimizing use of climate control system in a vehicle of claim 23, and further comprising the step of activating a venting system of the climate control system before the vehicle is turned on.

25. The method of optimizing use of climate control system in a vehicle of claim 23, wherein positioning of the control knob is performed by rotating the control knob about an axis extending through the control knob.

26. The method of optimizing use of climate control system in a vehicle of claim 23, wherein positioning of the control knob is performed by moving the control knob by a linear degree of freedom approximately parallel to an axis extending through the control knob.

27. The method of optimizing use of climate control system in a vehicle of claim 23, wherein positioning of the control knob is performed by controlling a graphical representation of the control knob through an already existing control device, the control knob being displayed through an on board display.

28. The method of optimizing use of climate control system in a vehicle of claim 23, wherein the set of numbers is a subset of numbers, and further comprising the step of selecting from the subset of numbers.

29. The method of optimizing use of climate control system in a vehicle of claim 23, wherein the set of numbers is a non-uniform but monotonically increasing subset of numbers, and further comprising the step of selecting from the non-uniform but monotonically increasing subset of numbers.

30. The method of optimizing use of climate control system in a vehicle of claim 23, and further comprising the step of detecting a position of the control knob in regard to the set of numbers.

31. The method of optimizing use of climate control system in a vehicle of claim 23, wherein activation of the climate control system occurs prior to passing of the expected time away from the vehicle.

32. A method to optimize an electrical charge algorithm, comprising the steps of:
providing to a charging module a quantified amount of energy over time required to charge a vehicle battery (KW/Hr);
providing to the charging module a maximal energy of a connection to the vehicle (KW);
providing to the charging module an energy price over time for charging the vehicle;
providing to the charging module an amount of time until the vehicle will be turned on by selecting a time parameter using a user controlled timing apparatus;
calculating an optimal charging rate including optimization of voltage, current and time through the charging module.
